(19) United States
(12) Patent Application Publication
(10) Pub. No.: US 2018/0107076 A1
(43) Pub. Date: Apr. 19, 2018

(54) Pixel Structure, Display Panel and Display Device

(71) Applicant: BOE Technology Group Co., Ltd., Beijing (CN)

(72) Inventors: Qiangtao Wang, Beijing (CN); Yun Sik Im, Beijing (CN)

(73) Assignee: BOE Technology Group Co., Ltd., Beijing (CN)

(21) Appl. No.: 15/541,758

(22) PCT Filed: Oct. 24, 2016
(86) PCT No.: PCT/CN2016/102996

§ 371 Date: Jul. 6, 2017

(30) Foreign Application Priority Data
Jan. 20, 2016 (CN) 201610038772.3

(51) Int. Cl. G02F 1/1343; G02F 1/1362

(52) U.S. Cl. CPC G02F 1/134309; G02F 2001/134345; G02F 1/136286

(57) ABSTRACT

A pixel structure, a display panel and a display device. The pixel structure includes a plurality of sub-pixel units arranged in an array, and first electrodes and second electrodes for forming liquid crystal electric fields in the plurality of sub-pixel units; the first electrodes and the second electrodes are capable of respectively forming first domain liquid crystal electric fields and second domain liquid crystal electric fields in every two adjacent sub-pixel units after energized; and the direction of the first domain liquid crystal electric field and the direction of the second domain liquid crystal electric field is different.

### TECHNICAL FIELD

Embodiments of the present disclosure relate to a pixel structure, a display panel and a display device.

### BACKGROUND

With the development of liquid crystal display (LCD) technology, display devices with high color performance become the developing direction of the technology. In order to ensure that the display device has better chromatic characteristics, people provide forward 2 pixel 2 domain (2P2D) pixel structure design. As illustrated in FIG. 1, in a 2P2D pixel structure, strip pixel electrodes 20 in areas of every two adjacent rows of sub-pixel units 10 have different extension directions (or slits of the pixel electrodes have different extension directions), and every two adjacent rows of strip pixel electrodes 20 are symmetrically arranged relative to gate lines 30 interposed therebetween. Thus, in the pixel structure, pixel electrodes and common electrodes in the areas of every two adjacent rows of sub-pixel units 10 may respectively form first domain liquid crystal electric fields (the electric fields for driving the deflection of liquid crystal molecules in a liquid crystal cell) and second domain liquid crystal electric fields with different directions, namely a certain included angle is between the directions of the liquid crystal electric fields formed in the areas of every two adjacent rows of sub-pixel units 10, so that the light-emitting directions in the areas of every two adjacent rows of sub-pixel units 10 can be mutually complementary. Therefore, the pixel structure has good light mixing effect and low color shift.

Although the above-mentioned 2P2D pixel structure can reduce color shift to a certain degree, there are also some defects. As the strip pixel electrode in each sub-pixel unit 10 has the same shape and extension direction in the row direction of the pixel structure, interference tends to occur between transmitted light in the row direction, and hence the final display panel tends to produce a fringe defect.

### SUMMARY

The present disclosure provides a pixel structure, a display panel and a display device, which are used for solving the problem of fringe defect of the 2P2D pixel structure in the prior art.

An embodiment of the present disclosure provides a pixel structure, comprising a plurality of sub-pixel units arranged in an array, and first electrodes and second electrodes for forming liquid crystal electric fields in the plurality of sub-pixel units; the first electrodes and the second electrodes are capable of respectively forming first domain liquid crystal electric fields and second domain liquid crystal electric fields in every two adjacent sub-pixel units after energized; and an included angle between a direction of the first domain liquid crystal electric field and a direction of the second domain liquid crystal electric field is greater than 0° and less than 180°.

For example, in the pixel structure, the first electrodes comprise: first strip electrodes disposed in sub-pixel units for forming the first domain liquid crystal electric fields; and second strip electrodes disposed in sub-pixel units for forming the second domain liquid crystal electric fields; an angle of an extension direction of the first strip electrodes relative to a row direction of the plurality of sub-pixel units is complementary to an angle of an extension direction of the second strip electrodes relative to a row direction of the plurality of sub-pixel units.

For example, in the pixel structure, the angle of the first strip electrodes relative to the row direction of the plurality of sub-pixel units is 75°-87°.

For example, in the pixel structure, the angle of the first strip electrodes relative to the row direction of the plurality of sub-pixel units is 83°.

For example, in the pixel structure, the first electrodes are common electrodes and the second electrodes are pixel electrodes; or the first electrodes are pixel electrodes and the second electrodes are common electrodes.

For example, in the pixel structure, a shape of each sub-pixel unit is an isosceles trapezoid; and in the plurality of sub-pixel units, every two adjacent sub-pixel units are in a shape of inverse trapezium with respect to each other.

For example, the pixel structure further comprises a plurality of gate lines and a plurality of data lines configured for encircling areas of the plurality of sub-pixel units; the plurality of sub-pixel units comprise sub-pixel units of three different colors; and in an extension direction of the gate lines, every three sub-pixel units with different colors form an isosceles trapezoid pixel unit.

For example, in the pixel structure, in an extension direction of the data lines, every two adjacent sub-pixel units have a same color.

For example, in the pixel structure, an included angle between a leg and a base of each isosceles trapezoid sub-pixel unit is 75°-87°.

For example, in the pixel structure, the included angle between the leg and the base of each isosceles trapezoid sub-pixel unit is 83°.

Another embodiment of the present disclosure provides a display panel comprising any one of the above-described pixel structure.

Still another embodiment of the present disclosure provides a display device, comprising the above-described display panel0.

### BRIEF DESCRIPTION OF THE DRAWINGS

In order to clearly illustrate the technical solution of the embodiments of the disclosure, the drawings of the embodiments will be briefly described in the following; it is obvious that the described drawings are only related to some embodiments of the disclosure and thus are not limitative of the disclosure.

FIG. 1 is a schematic structural view of a 2D2D pixel structure;

FIG. 2 is a schematic structural view of a pixel structure provided by an embodiment of the present disclosure;

FIG. 3 is a schematic structural view of a pixel structure provided by another embodiment of the present disclosure; and

FIGS. 4A and 4B are schematic sectional views of the pixel structure provided by an embodiment of the present disclosure.

### DETAILED DESCRIPTION

In order to make objects, technical details and advantages of the embodiments of the disclosure apparent, the technical solutions of the embodiments will be described in a clearly and fully understandable way in connection with the drawings related to the embodiments of the disclosure. Apparently, the described embodiments are just a part but not all of the embodiments of the disclosure. Based on the described embodiments herein, those skilled in the art can obtain other embodiment(s), without any inventive work, which should be within the scope of the disclosure.

Unless otherwise defined, all the technical and scientific terms used herein have the same meanings as commonly understood by one of ordinary skill in the art to which the present disclosure belongs. The terms “first,” “second,” etc., which are used in the description and the claims of the present application for disclosure, are not intended to indicate any sequence, amount or importance, but distinguish various components. Also, the terms such as “a,” “an,” etc., are not intended to limit the amount, but indicate the existence of at least one. The terms “comprise,” “comprising,” “include,” “including,” etc., are intended to specify that the elements or the objects stated before these terms encompass the elements or the objects and equivalents thereof listed after these terms, but do not preclude the other elements or objects. The phrases “connect”, “connected”, etc., are not intended to define a physical connection or mechanical connection, but may include an electrical connection, directly or indirectly. “On,” “under,” “right,” “left” and the like are only used to indicate relative position relationship, and when the position of the object which is described is changed, the relative position relationship may be changed accordingly.

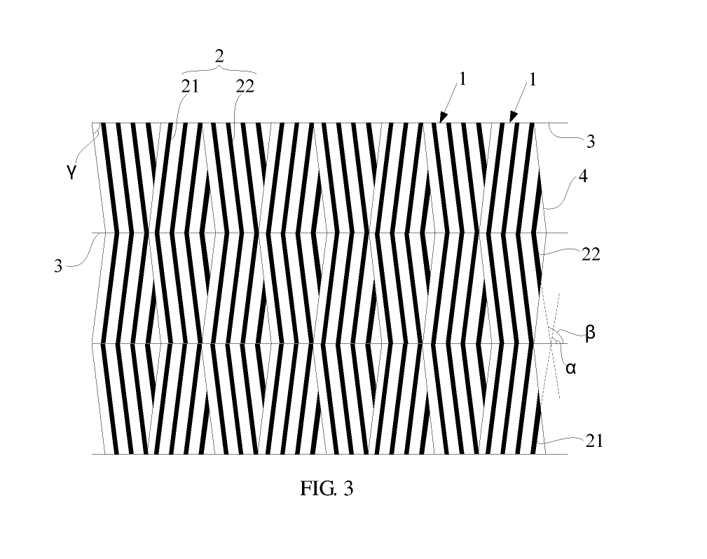

As illustrated in FIGS. 2 and 3, an embodiment of the present disclosure provides a pixel structure, which comprises a plurality of sub-pixel units 1 arranged in an array, and first electrodes 2 and second electrodes for forming liquid crystal electric fields in the plurality of sub-pixel units 1. The first electrodes 2 and the second electrodes may respectively form first domain liquid crystal electric fields and second domain liquid crystal electric fields in every two adjacent sub-pixel units 1 after energized (namely applied with driving voltage), and an included angle between the direction of the first domain liquid crystal electric filed and the direction of the second domain liquid crystal electric field is greater than 0° and less than 180°.

In the pixel structure, the first domain liquid crystal electric field and the second domain liquid crystal electric field are respectively formed in every two adjacent pixel units 1, and the included angle between the directions of the first domain liquid crystal electric field and the second domain liquid crystal electric field is greater than 0° and less than 180°, namely the first domain liquid crystal electric field and the second domain liquid crystal electric field have different directions. Thus, in the pixel structure, the liquid crystal electric fields in every two adjacent sub-pixel units 1 have different directions, and furthermore the shape and/or settings of the first electrodes 2 and/or the second electrodes in two adjacent sub-pixel units 1 are also different.

For instance, the shape and/or settings of the first electrodes 2 and/or the second electrodes in every two adjacent sub-pixel units 1 are different in the row direction (horizontal direction) of the plurality of sub-pixel units 1; and the shape and/or settings of the first electrodes 2 and/or the second electrodes in every two adjacent sub-pixel units 1 are also different in the column direction (vertical direction) of the plurality of sub-pixel units 1. In this case, light from a backlight module suffers from poor mutual coherence after running through the plurality of sub-pixel units 1, so light running through the entire pixel structure can be difficult to produce interference, and hence interference fringes cannot be easily produced after the light runs through the pixel structure.

Therefore, the pixel structure provided by the embodiment of the present disclosure will not easily produce the fringe defect of the display panel.

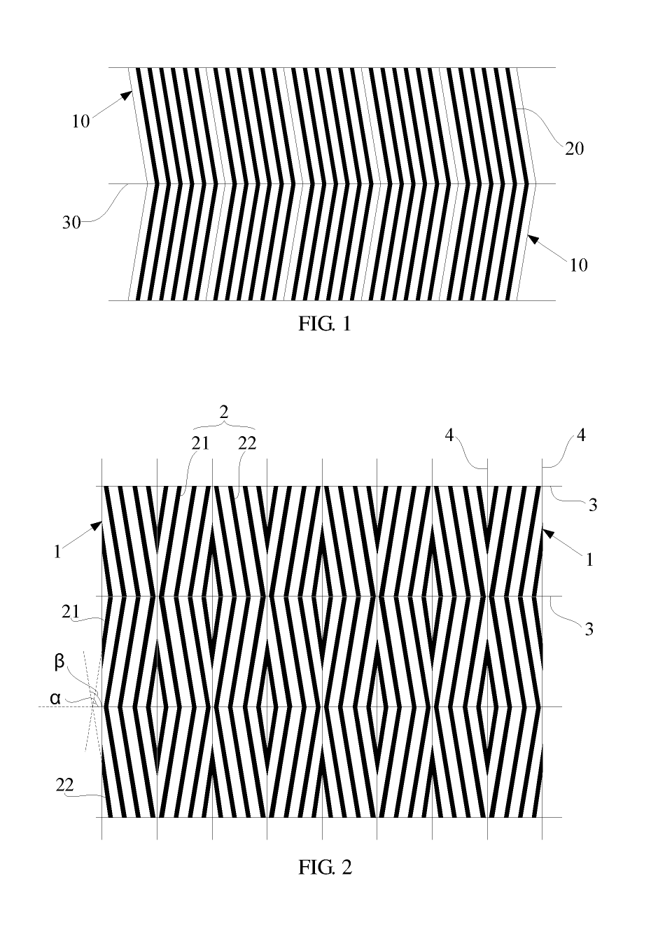

In addition, in the above-described pixel structure, the liquid crystal electric fields in every two adjacent sub-pixel units 1 have different directions, namely the liquid crystal electric fields in every two adjacent sub-pixel units 1 have different directions in both the row direction of the plurality of sub-pixel units 1 and the column direction of the plurality of sub-pixel units 1. Thus, in the row direction of the plurality of sub-pixel units 1, the light-emitting directions in areas of every two adjacent sub-pixel units 1 can be at least mutually complementary to a certain degree; and in the column direction of the plurality of sub-pixel units 1, the light-emitting directions in the areas of every two adjacent sub-pixel units 1 can also be at least mutually complementary to a certain degree. Therefore, compared with the 2P2D pixel structure as illustrated in FIG. 1, the pixel structure provided by the embodiment of the present disclosure allows the transmitted light to produce better light mixing effect, and hence has lower color shift and better chromatic characteristic.

As illustrated in FIGS. 2 and 3, in a pixel structure provided by a preferred embodiment, a plurality of gate lines 3 are extended in parallel along the horizontal direction; a plurality of data lines 4 are extended in parallel along the vertical direction; the gate lines 3 and the data lines 4 are intersected with each other to define a plurality of sub-pixel units; the second electrodes may be plate electrodes; the second electrodes in adjacent sub-pixel units may be electrically connected with each other, or may be independent of each other and hence be independently driven; the first electrodes 2 may include first strip electrodes 21 disposed in sub-pixel units 1 for forming the first domain liquid crystal electric fields, and second strip electrodes 22 disposed in sub-pixel units 1 for forming the second domain liquid crystal electric fields; and the first strip electrodes 21 and the second strip electrodes 22 may be electrically connected with each other, or be independent of each other and hence be independently driven. An angle α formed between the extension direction of the first strip electrodes 21 (or the extension direction of slits in the first strip electrodes 21) and the row direction of the plurality of sub-pixel units 1 (the extension direction of the gate lines 3 or the extension direction of the data lines 4) is complementary to an angle β formed between the extension direction of the second strip electrodes 22 (or the extension direction of slits in the second strip electrodes 22) and the row direction of the plurality of sub-pixel units 1. In the pixel structure provided by the embodiment, the first domain liquid crystal electric fields are formed between the first strip electrodes 21 and the second electrodes, and the second domain liquid crystal electric fields are formed between the second strip electrodes 22 and the second electrodes. Because the angles of the first strip electrodes 21 and the second strip electrodes 22 respectively relative to the row direction are complementary to each other, the directions of the first domain liquid crystal electric field and the second domain liquid crystal electric field have better complementarity, namely the directions of the liquid crystal electric fields in two adjacent sub-pixel units 1 have better complementarity. Thus, better light mixing effect can be produced after the light runs through the pixel structure, so that the color shift can be lowered and the chromatic characteristic can be better.

For instance, in an embodiment, the first strip electrodes 21 and the second strip electrodes 22 in two adjacent sub-pixel units in the row direction are symmetrically arranged relative to the data lines 4 between the sub-pixel units, and the first strip electrodes 21 and the second strip electrodes 22 in two adjacent sub-pixel units in the column direction are symmetrically arranged relative to the gate lines 3 between the sub-pixel units.

As illustrated in FIGS. 2 and 3, an improved embodiment is provided on the basis of this embodiment, in which a plurality of gate lines 3 are extended in parallel along the horizontal direction; a plurality of data lines 4 are extended along the vertical direction in roughly “S” shape; and adjacent data lines 4 have opposite bending directions. In the embodiment, an angle α of the extension direction of first strip electrodes 21 relative to the row direction of a plurality of sub-pixel units 1 may be 75°-87°. Moreover, preferably, the angle α of the extension direction of the first strip electrodes 21 relative to the row direction of the plurality of sub-pixel units 1 is 83°.

As illustrated in FIGS. 2 and 3, an improved embodiment is provided on the basis of the embodiments, in which the first electrodes 2 may be common electrodes and configured to apply common voltage, and the second electrodes may be pixel electrodes and configured to apply data voltage. That is to say, in the pixel structure provided by the embodiment, the common electrodes may include two parts, namely the first strip electrodes 21 and the second strip electrodes 22, and the pixel electrodes may be plate electrodes. In another embodiment, the first electrodes 2 may be pixel electrodes and the second electrodes may be common electrodes. That is to say, in the pixel structure provided by the embodiment, the pixel electrodes may include two parts, namely the first strip electrodes 21 and the second strip electrodes 22, and the common electrodes may be a plate electrode(s).

As illustrated in FIG. 3, in a pixel structure provided by a preferred embodiment, the shape of each sub-pixel unit 1 may be an isosceles trapezoid. Moreover, in the plurality of sub-pixel units 1, every two adjacent sub-pixel units are in the shape of inverse trapezium with respect to each other.

In the pixel structure provided by an embodiment, each sub-pixel unit 1 is arranged in the shape of an isosceles trapezoid; and in the row direction and the column direction of the plurality of sub-pixel units 1, every two adjacent sub-pixel units 1 are in the shape of inverse trapezium with respect to each other, namely being inverted to each other. The design can ensure the close arrangement of adjacent sub-pixel units 1.

In the pixel structure as illustrated, for instance, in FIG. 1, the shape of the sub-pixel unit is usually a rectangle or a parallelogram. As rectangles and parallelograms with small area may be generally similar to strips, when the sub-pixel unit is small, each rectangular or parallelogrammic sub-pixel unit area may be equivalent to a strip light-emitting area. In this case, when light runs through a plurality of adjacent sub-pixel units, the light is equivalent to run through a plurality of parallel strip light-emitting areas, so that emergent light tends to produce interference, and hence the fringe defect can be caused. In the pixel structure provided by the embodiment, as illustrated in FIG. 3, each sub-pixel unit 1 is arranged in the shape of an isosceles trapezoid, and every two adjacent sub-pixel units 1 are mutually inverted. At this point, areas of a plurality of sub-pixel units 1 are not similar to a plurality of parallel strip light-emitting areas again, so light has poor mutual coherence after running through the pixel structure, namely emergent light running through the pixel structure will not easily produce interference. Therefore, the pixel structure provided by the embodiment can effectively avoid the fringe defect.

As illustrated in FIG. 3, moreover, the pixel structure provided by the embodiment of the present disclosure may further comprise a plurality of gate lines 3 and a plurality of data lines 4 configured for encircling the areas of the plurality of sub-pixel units 1. For instance, the gate lines 3 and the data lines 4 are wirings at the edges of the sub-pixel units respectively arranged along the row and column directions. Thus, the setting of the pixel structure, namely the shape of the sub-pixel units 1 is an isosceles trapezoid and every two adjacent sub-pixel units 1 are in the shape of inverse trapezium with respect to each other, not only can effectively avoid the fringe defect but also can ensure the consistent length of all the gate lines 3 and the consistent length of all the data lines 4, and hence can ensure that the sub-pixel units 1 have the same charging rate.

As illustrated in FIG. 3, on the basis of the embodiment, in another preferred embodiment, a plurality of sub-pixel units 1 may include sub-pixel units 1 of three different colors (e.g., RGB); in the extension direction of gate lines 3, every three sub-pixel units 1 with different colors form an isosceles trapezoid pixel unit (for instance, the first three sub-pixel units on the left side of the first row in FIG. 3); and in the extension direction of data lines 4, for instance, every two adjacent sub-pixel units 1 have the same color.

As illustrated in FIG. 3, in the pixel structure provided by the embodiment, in the extension direction of the gate lines 3, every three sub-pixel units 1 with different colors form an isosceles trapezoid pixel unit, namely the sub-pixel units 1 of three colors are arranged in sequence with an interval. Moreover, because the liquid crystal electric fields in every two adjacent sub-pixel units 1 are complementary to each other, in the extension direction of the gate lines 3 the directions of the liquid crystal electric fields in every two adjacent sub-pixel units 1 of the same color are complementary to each other. In the extension direction of the data lines 4, every two adjacent sub-pixel units 1 have the same color, and the directions of the liquid crystal electric fields in every two adjacent sub-pixel units 1 are complementary to each other. Thus, in the extension direction of the data lines 4, the directions of the liquid crystal electric fields in every two adjacent sub-pixel units 1 of the same color are also complementary to each other. Therefore, in the pixel structure provided by the embodiment, the direction of the liquid crystal electric field of each sub-pixel unit 1 is complementary to the directions of the liquid crystal electric fields of four sub-pixel units 1 having the same color and being adjacent to the sub-pixel unit in the up, down, left and right sides, namely the light-emitting directions of adjacent sub-pixel units with the same color can be mutually complementary. Therefore, the entire pixel structure can produce good light mixing effect in various light-emitting directions, namely the pixel structure has low color shift and good chromatic characteristic when viewed from various directions.

As illustrated in FIG. 3, in one example of the embodiment, an included angle γ between the leg and the base of each isosceles trapezoid sub-pixel unit 1 may be 75°-87°. Moreover, the included angle γ between the leg and the base of each isosceles trapezoid sub-pixel unit 1 is 83°.

As each sub-pixel unit 1 is encircled by two gate lines 3 and two data lines 4 adjacent to the sub-pixel unit, when the included angle γ between the leg and the base of each sub-pixel unit 1 is too small, the coverage area of the gate lines 3 and the data lines 4 of the entire pixel structure can be too large, namely the areas of a black matrix (BM) can be large, so that the aperture ratio of the pixel structure can be small. In the embodiment, the setting of the included angle γ between the leg and the base of the sub-pixel unit 1 not only can avoid the defect of interference fringes of the data lines 4 but also can avoid too low aperture ratio of the pixel structure.

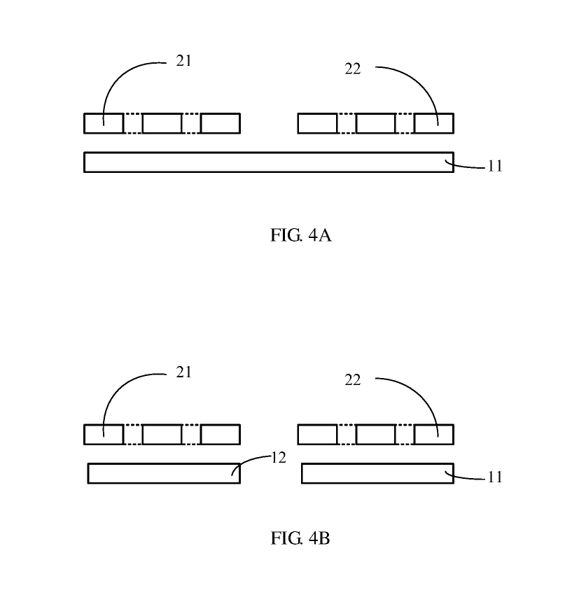

FIG. 4A is a schematic sectional view of a pixel structure provided by an embodiment of the present disclosure. As illustrated in the figure, two strip electrodes 21 and 22 of the first electrodes are arranged in the same layer and arranged in two sub-pixel units. The dotted line parts in each strip electrode represent slits between electrode strips. The second electrode 11 is a plate electrode, and the sub-pixel units are provided with the two strip electrodes 21 and 22 sharing the second electrode 11. The first electrodes and the second electrodes are spaced from each other by an insulating layer.

FIG. 4B is a schematic sectional view of another pixel structure provided by an embodiment of the present disclosure. As illustrated in the figure, two strip electrodes 21 and 22 of the first electrodes are arranged in the same layer and arranged in two sub-pixel units. The dotted line parts in each strip electrode represent slits between electrode strips. Second electrodes 11 and second electrodes 12 are plate electrodes and are respectively disposed in the sub-pixel units provided with the two strip electrodes 21 and 22. The first electrodes and the second electrodes are spaced from each other by an insulating layer.

An embodiment of the present disclosure further provides a display panel, which may comprise the pixel structure provided by any of the foregoing embodiments. The display panel provided by the embodiment of the present disclosure has a low color shift and good chromatic characteristics.

The display panel comprises an array substrate and an opposing substrate which are arranged opposite to each other to form a liquid crystal cell, and liquid crystal materials are filled in the liquid crystal cell. The opposing substrate is, for instance, a color filter (CF) substrate. The LCD panel may further comprise a backlight module for providing backlight for the array substrate. In the embodiment of the present disclosure, in the first electrodes and the second electrodes, the pixel electrodes may be formed on the array substrate, and the common electrodes may be formed on the array substrate or the opposing substrate. Particularly, when the common electrodes are formed on the array substrate, the display panel is a planar electric field type; and when the common electrodes are formed on the opposing substrate, the display panel is a vertical electric field type. In one example, the display panel is an advanced super dimension switch (ADS) type thin-film transistor liquid crystal display (TFT-LCD), in which multidimensional electric fields are formed by electric fields produced at edges of slit electrodes in the same plane and electric fields produced between a slit electrode layer and a plate electrode layer, so that liquid crystal molecules at all the orientations between the slits electrodes and over electrodes in the liquid crystal cell can be rotated, and hence the working efficiency of the liquid crystals can be improved and the light transmittance can be increased.

An embodiment of the present disclosure further provides a display device, which may comprise the display panel provided by the embodiment. The display device provided by the embodiment of the present disclosure has a low color shift and good chromatic characteristics.

The display device, for instance, may be any product or component with display function such as a mobile phone, a tablet PC, a TV, a display, a notebook computer, a digital picture frame and a navigator.

What are described above is related to the illustrative embodiments of the disclosure only and not limitative to the scope of the disclosure; the scopes of the disclosure are defined by the accompanying claims.

The application claims priority to the Chinese patent application No. 201610038772.3, filed on Jan. 20, 2016, the entire disclosure of which is incorporated herein by reference as part of the present application.

1. A pixel structure, comprising a plurality of sub-pixel units arranged in an array, and first electrodes and second electrodes for forming liquid crystal electric fields in the plurality of sub-pixel units, wherein
the first electrodes and the second electrodes are capable of respectively forming first domain liquid crystal electric fields and second domain liquid crystal electric fields in every two adjacent sub-pixel units after energized; and
an included angle between a direction of the first domain liquid crystal electric field and a direction of the second domain liquid crystal electric field is greater than 0° and less than 180°.

2. The pixel structure according to claim 1, wherein the first electrodes comprise:
first strip electrodes disposed in sub-pixel units for forming the first domain liquid crystal electric fields; and
second strip electrodes disposed in sub-pixel units for forming the second domain liquid crystal electric fields;
wherein an angle of an extension direction of the first strip electrodes relative to a row direction of the plurality of sub-pixel units is complementary to an angle of an extension direction of the second strip electrodes relative to a row direction of the plurality of sub-pixel units.

3. The pixel structure according to claim 2, wherein the angle of the first strip electrodes relative to the row direction of the plurality of sub-pixel units is 75°-87°.

4. The pixel structure according to claim 3, wherein the angle of the first strip electrodes relative to the row direction of the plurality of sub-pixel units is 83°.

5. The pixel structure according to claim 1, wherein
the first electrodes are common electrodes and the second electrodes are pixel electrodes; or
the first electrodes are pixel electrodes and the second electrodes are common electrodes.

6. The pixel structure according to claim 1, wherein a shape of each sub-pixel unit is an isosceles trapezoid; and in the plurality of sub-pixel units, every two adjacent sub-pixel units are in a shape of inverse trapezium with respect to each other.

7. The pixel structure according to claim 6, further comprising a plurality of gate lines and a plurality of data lines configured for encircling areas of the plurality of sub-pixel units;
the plurality of sub-pixel units comprise sub-pixel units of three different colors; and in an extension direction of the gate lines, every three sub-pixel units with different colors form an isosceles trapezoid pixel unit.

8. The pixel structure according to claim 7, wherein in an extension direction of the data lines, every two adjacent sub-pixel units have a same color.

9. The pixel structure according to claim 6, wherein an included angle between a leg and a base of each isosceles trapezoid sub-pixel unit is 75°-87°.

10. The pixel structure according to claim 9, wherein the included angle between the leg and the base of each isosceles trapezoid sub-pixel unit is 83°.

11. A display panel, comprising the pixel structure according to claim 1.

12. A display device, comprising the display panel according to claim 10.
